(19) United States
(12) Patent Application Publication
(10) Pub. No.: US 2010/0049627 A1
(43) Pub. Date: Feb. 25, 2010

(54) Audio Communication Web Site Integration

(75) Inventors: Birgit Andrea Geppert, Basking Ridge, NJ (US); Reinhard Peter Klemm, Basking Ridge, NJ (US); Frank Michael Roessler, Basking Ridge, NJ (US)

Correspondence Address: Avaya;DEMONT & BREYER, LLC, 100 COMMONS WAY, STE 250, HOLMDEL, NJ, 07733, US

(73) Assignee: Avaya Inc., Basking Ridge, NJ (US)

(21) Appl. No.: 12/194,336

(22) Filed: Aug. 19, 2008

(51) Int. Cl. G06F 17/30; G06Q 30/00; G06Q 90/00

(52) U.S. Cl. 705/27; 705/26

(57) ABSTRACT

The present invention provides a method of communication between customers of a retail Web site. In particular, the illustrative embodiment provides a computer implemented method comprises authenticating a first customer and a second customer to enable the first and second customers to access a retail Web site via the Internet, displaying a representation of the first customer viewing a Web page of the retail Web site and a representation of the second customer viewing the Web page of the retail Web site, and enabling audio communication between the first customer and the second customer.

### FIELD OF THE INVENTION

The present invention relates to telecommunications in general, and, more particularly, to audio communication and retail Web sites.

### BACKGROUND OF THE INVENTION

Social networking Web sites such as MySpace and Facebook are online destinations in which registered users may establish networks of friends, post personal profiles, access blogs and interact with other users. Second life is an advanced social networking Web site in which a downloadable client program enables registered users to identify and interact with each other via text or audio communication. Social networking Web sites offer users the ability to exchange ideas, experience and advice. Users, however, are not the only ones that benefit from such user interaction. The companies that own and operate such Web sites also benefit from such user-to-user interaction. That is, communication between users offers several advantages such as free advertising via user “word-of-mouth” as well as user evangelism, loyalty, camaraderie, feedback and test marketing.

Unlike Social networking Web sites, retail Web sites (i.e., Web sites that market products or services) do not offer the same vehicles for customer-to-customer interaction. That is, while virtually all retail companies now host (or have hosted) elaborate Web sites in which customers may view and possibly purchase products or services, the means for communication is less sophisticated. In order for one customer to communicate with another customer, the initiating customer must actually post a message for other customers in a product review or forum Web page of the retail Web site. Certain retail Web sites do not even offer this type of customer-to-customer interaction. Other retail Web sites merely enable customers to communicate with a customer service representative via instant messaging. In the event a customer has a question about a product or service, the customer may initiate a real-time conversation with a customer representative via instant messaging. While these methods of communication are generally adequate, such communication does not provide a retail company and its customers with the benefits associated with the social networking Web sites described above.

### SUMMARY OF THE INVENTION

The present invention provides a method of communication between customers of a retail Web site. In particular, the illustrative embodiment provides a computer implemented method comprising authenticating a first customer and a second customer to enable the first and second customers to access a retail Web site via the Internet, displaying a representation of the first customer viewing a Web page of the retail Web site and a representation of the second customer viewing the Web page of the retail Web site, and enabling audio communication between the first customer and the second customer.

### BRIEF DESCRIPTION OF THE DRAWINGS

FIG. 1 depicts a block diagram of the salient components of communications system 100 in accordance with the illustrative embodiment of the present invention.

FIG. 2 depicts a block diagram of the salient components of each client 102-i shown in FIG. 1.

FIG. 3 depicts the salient features of Web page 300 displayed on the display of client 102-i that are associated with the operation of the illustrative embodiment.

FIG. 4 depicts a flowchart of the salient tasks associated with the operation of the illustrative embodiment.

### DETAILED DESCRIPTION

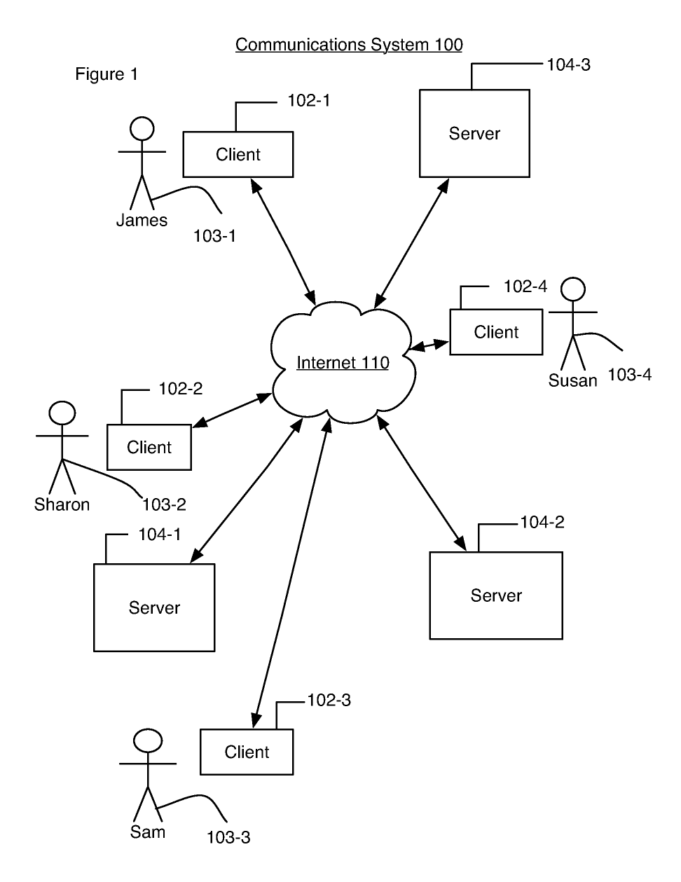

FIG. 1 depicts a block diagram of the salient components of communication system 100 in accordance with the illustrative embodiment of the present invention.

Communication system 100 comprises: clients 102-1 through 102-4, customers 103-1 through 103-4, servers 104-1 through 104-4 and Internet 110, interconnected as shown. Customers 103-1 through 103-4 are associated with clients 102-1 through 102-4, respectively. Customers 103-1 through 103-4 are identified in the figures as James, Sharon, Sam and Susan, respectively. For purposes of this disclosure, customers include visitors to a retail Web site as well as individuals or other entities that actually research goods or services via a retail Web site.

Although the illustrative embodiment depicts three customers, three clients and three servers, it will be clear to those skilled in the art, after reading this disclosure, how to make and use alternative embodiments of the present invention that use any number of customers, clients and servers.

Client 102-i is a computer that comprises hardware and software for performing the tasks described in detail below and in the accompanying figures. It will be clear to those skilled in the art that each client 102-i other hardware and software components (e.g., operating system such as Microsoft Windows or Apple Tiger) to enable the client to function properly. In accordance with the illustrative embodiment, each client 102-i is connected to the Internet 110 via an Internet Service Provider (ISP) using conventional components including an Ethernet card (typically installed within a client), router and cable modem or DSL connection. In accordance with the illustrative embodiment, each of clients 102-1 through 102-4 are identical, but it will be clear to those skilled in the art, after reading this disclosure, how to make and use alternative embodiments of the present invention in which any or all of the clients are not identical.

Servers 104-1 through 104-4 each, as is well known to those skilled in the art, may represent one or more computers that provide several services for clients 102-1 through 102-4. (Each computer has a processor, memory, operating system and other components known to those skilled in the art.) At least one server 102-i incorporates software that allows the server to function as a Web server to deliver Web pages, as is known to those skilled in the art. One or more Web servers store one or more Web sites. As known by those skilled in the art, clients 102-1 through 102-4 may access a Web page (i.e., content) of a Web site stored on a Web server via a Web browser (using HTTP protocol request) stored on the client as discussed below.

The Internet 110 is the ubiquitous packet network and it will be clear to those skilled in the art how to extend and use the Internet.

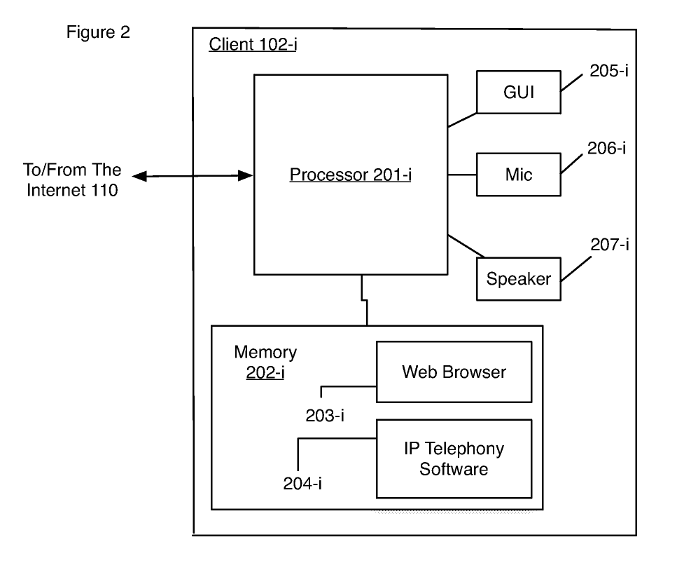

FIG. 2 depicts a block diagram of the salient components of each client 102-i shown in FIG. 1. Each client 102-i comprises a processor 201-i, memory 202-i, Web browser 203-i, Internet Protocol (IP) telephony software 204-i, graphical user interface 205-i, microphone 206-i and speaker 207-i.

Processor 201-i is hardware, as is well known in the prior art, for executing commands in memory 202-i, for storing into and retrieving data from memory 202-i, for transmitting packets to and receiving packets from the Internet, and for interfacing with graphical user interface 205-i, microphone 206-i, and speaker 207-i. It will be clear to those skilled in the art how to make and use processor 201-i.

Memory 202-i is a non-volatile storage, as is well known in the art, for storing programs and data, including Web browser 203-i and IP telephony software 204-i. It will be clear to those skilled in the art how to make and use memory 202-i.

Web browser 203-i is a program or application, as is well known in the art, for interpreting the markup of files in HTML, formatting them into Web pages and displaying them to the customer. Two common Web browsers are Microsoft Internet Explorer and Mozilla Firefox. There are many others. It will be clear to those skilled in the art how to make and use browser 203-i.

IP telephony software 204-i is a program or application, as is well known in the art, for enabling audio and possible video communication (among other types) between customers (e.g., 103-1 through 103-4, etc.) over the Internet 110. Skype is an example of conventional IP telephony software 204-i. Skype is a Voice Over Internet Protocol Service (VOIP) that permits customers to speak to one another via the Internet 110. It will be clear to those skilled in the art how to make and use IP telephony software 204-i. With IP telephony software 204-i, a customer may use microphone 206-i and speaker 207-i (as described below). Alternatively, a customer may use an Internet Protocol terminal, a wireline terminal or wireless terminal to communicate with another customer, provided these terminals are properly configured to enable communication via such telephony software.

Graphical user interface 205-i comprises a display, keyboard and pointing device for enabling a customer of client 102-i to control computing of client 102-i, Web browser 203-i and IP telephony software 204-i in particular. It will be clear to those skilled in the art how to make and use graphical user interface 205-i.

Microphone 206-i is an electro-acoustic transducer for converting an acoustic signal (e.g., speech, etc.) into electro-magnetic representation of that acoustic signal. It will be clear to those skilled in the art how to make and use microphone 206-i.

Speaker 207-i is an electro-acoustic transducer for converting an electro-magnetic signal into an acoustic representation of that electro-magnetic signal. It will be clear to those skilled in the art how to make and use speaker 207-i.

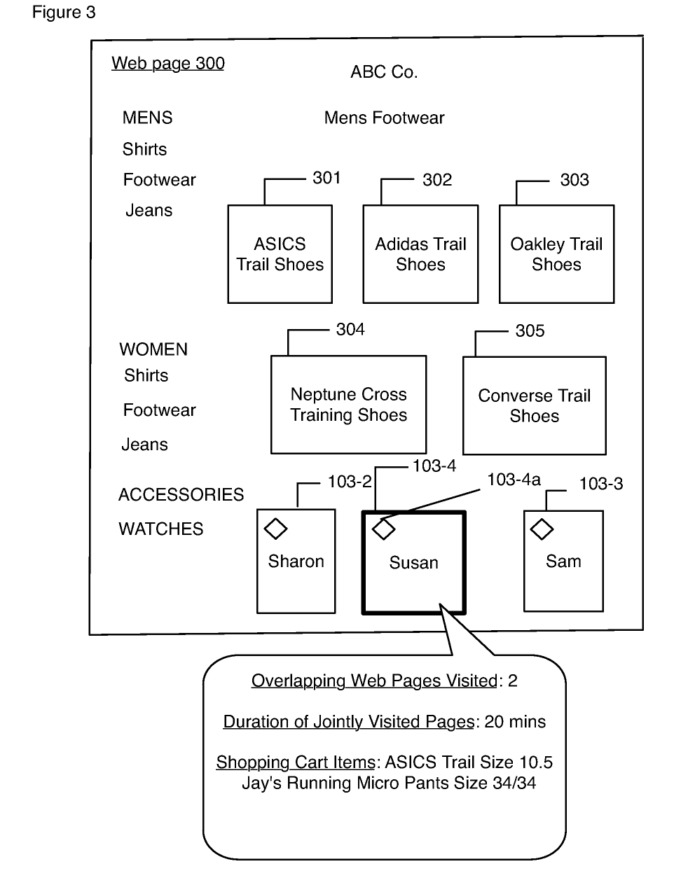

FIG. 3 depicts the salient features of Web page 300 displayed on the display of client 102-i that are associated with the operation of the illustrative embodiment. In accordance with the illustrative embodiment, Web page 300 is one of many Web pages of a retail Web site stored on a Web server owned and operated by ABC Company or another company on behalf of ABC Company. ABC is a retail company that offers clothing, footwear, sunglasses, watches and other retail products to its customers through its Website. However, it will be understood by those skilled in the art, after reading this disclosure that the retail Web site may market the services of a company.

Along the left side of Web page 300, several high level topics are shown. Each topic is associated with a hyperlink which, when a customer clicks such topic, will call and retrieve another Web page with related product items. In the body of Web page 300, several types of men's footwear items are shown including ASICS® trail shoes 301, Adidas® trail shoes 302, Oakley® trail shoes 303, Neptune cross-training shoes 304 and Converse trail shoes 305. Each of these footwear items is associated with a hyperlink. If a customer clicks an item, e.g., ASICS® trail shoes 301, a hyperlink will retrieve a further Web page and it will appear in place of Web page 300 wherein more details of the ASICS® trail shoes are shown and described.

In accordance with the illustrative embodiment of the present invention, Web page 300 reserves an area in which visitors (i.e., customers) viewing that Web page are shown. On Web page 300, there are several customers viewing Web page 300. Each customer 103-2 (Sharon), 103-3 (Sam), 103-4 (Susan) is represented as an icon. Although the illustrative embodiment depicts icons as representations for individual customers, it will be clear to those skilled in the art, after reading this disclosure, how to make and use alternative embodiments of the present invention that use any representation for a customer. Each customer may view any other customer viewing the same Web page. In the event the number of visitors (i.e., customers) viewing a Web page are too numerous for display, individual icons will be grouped.

In accordance with the illustrative embodiment of the present invention, each icon or a section thereof acts as a “Get-In-Touch” button wherein one customer may get in touch with another customer viewing the same Web page. In the event one customer wishes to initiate communication with another customer, he or she merely clicks on the Get-In-Touch button (i.e., applicable icon or section thereof) and Web browser 203-i, as known by those skilled in the art, will retrieve IP telephony software 204-i (if not already booted and displayed) on the applicable client 102-i to enable such communication and initiate a call. In the event, IP software is already booted and on display, a call will be initiated between customers. For example, if Sharon desires to speak with Susan about a particular product, Sharon would click on Susan's “Get-In-Touch” button 103-4a (diamond shape within icon) to initiate a call. Upon such initiation, Web browser 203-i would retrieve, e.g., Skype to enable audio (voice) and possibly video communication with Susan. Susan will have the opportunity to accept or reject the call as desired. In this respect, a customer may immediately engage in a real-time discussion with other customers, thereby emulating spontaneous face-to-face conversations in a real retail store. Alternatively, a customer may approach another customer who may decide to reject or postpone the interaction, which could be implemented by an icon changing color, shape, or size. If a customer has a question related to Web page content, it is likely that another customer may have an answer for the question.

In certain embodiments, an icon representing a first customer may provide a variety of context information about that first customer. The context information will be relevant or personalized to second customer to help that second customer decide whether to initiate a conversation with the first customer. That is, the context information may be specifically tailored to a viewing customer. Such information may include overlap in previously visited Web pages, duration of time viewing jointly visited Web pages, common shopping cart items and/or any other information relevant to a customer for selecting and establishing communication with another customer. A Web site may obtain or derive this context information using conventional Web analytical processes.

The retail Web site may use the context information to identify relevant customers for possible communication by another customer. A client will display such context information when a customer initiates some action such as moving a pointing device on or within the area of the icon representing a customer or actually clicking on specific part of an icon. In either case, a menu, pop-up or other signal or symbol may appear with the context information. The Web site may use this information to identify and alert a customer of relevant customers for communication by highlighting such customers of overlapping interest, while minimizing and grouping the rest of the customers.

In FIG. 3, the icon that represents customer 103-4 (Susan) is highlighted in bold to alert a particular customer, e.g., 103-1 that customer 103-4 may be worthy of establishing communication based on context information of customer 103-4 that is personalized to customer 103-1. In this respect, customer 103-1 has moved his pointing device (not shown) over the icon that represents customer 103-4. Client 102-1 then displays a pop-down balloon with context information. In particular, James may learn whether both (he and Susan) have visited the same Web pages, how long both have spent on such jointly viewed Web pages and whether both have chosen similar items for purchase (i.e., shopping cart items). James may select or decide to initiate a call and communicate with Susan once this context information is displayed. It will be clear to those skilled in the art after reading this disclosure, that context information may be presented in other alternative ways.

It will be clear to those skilled in the art that communication may be initiated between customers in accordance with alternative embodiments of the present invention. For example, each Web page may employ a chat group that is consistently present for each page when a customer posts a question. Another customer may initiate a one-on-one audio (voice) conversation to answer the question. A Web page may also identify customers currently communicating and allow other customers to join the conversation. Depending on availability and other factors such as communication volume, an assistant icon representing a regular call center agent may be displayed to enable other customers to converse with store employees.

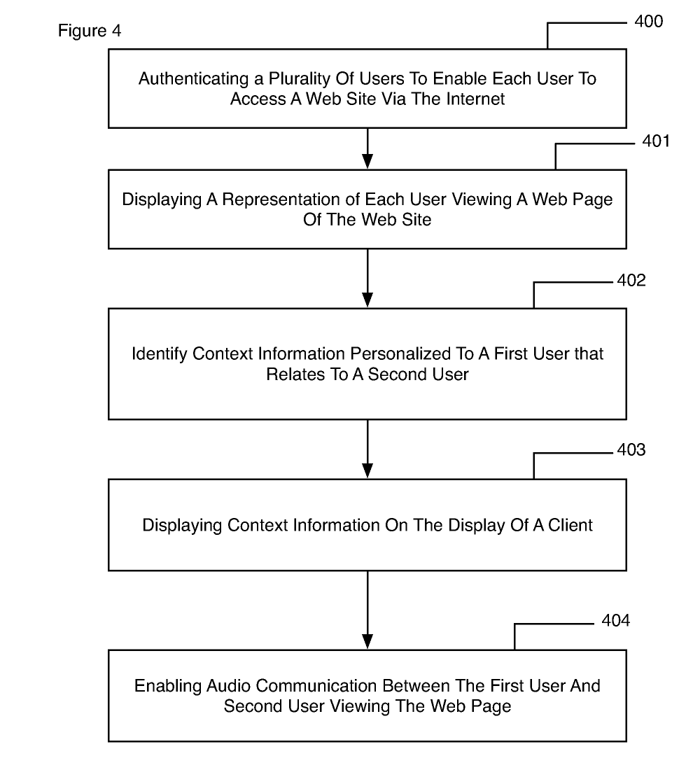

FIG. 4 depicts a flowchart of the salient tasks associated with the operation of the illustrative embodiment.

At task 400, server 104-i functioning as a Web server has authenticated a plurality of customers 103-i to enable such customers 103-i to access various Web pages (i.e., content) of retail Web site via the Internet 110. In most cases, authentication is performed through a Home page of the retail Web site. Client 102-i will display a Home page at a customer's request. Customer 103-i will then “login” to a retail Web site, i.e., the customer 102-i will enter specific personal information via the Home page of the retail Web site. Login typically requires that a customer first establish an account on the retail Web site wherein a customer name and password are chosen or created for authentication. In addition, other personal information such as credit card account information may be required to enable a customer to purchase products via the retail Web site. Server 104-i will then authenticate the customer 102-i by such information. Although the customer's personal information typically consists of a user name and password, those skilled in the art will know how to make and use alternative embodiments in which other authentication processes and information are used.

In the event a customer requests a Web page other than a Home page of the retail Web site, the Web server will typically return the Home page for login and authentication. Once a customer is authenticated, the Web server may return the originally requested Web page. Alternatively, the customer may be required to activate a hyperlink to receive the requested Web page. Task 400 may require that a customer enter additional information relating to his or her purchasing habits or other things. The collected information may be used for deriving context information that may be useful to another customer when deciding whether to initiate communication (i.e., a conversation and possibly video if available).

At task 401, client 102-i displays Web page 300 wherein representations of each customer 103-i viewing Web page 300 is presented. There may be any number of customers viewing a Web page at one time.

At task 402, the Web server (i.e. server 104-i) will collect and identify context information personalized to a first customer that relates to a second customer. As indicated, the Web server will use conventional Web analytical processes to collect and present such context information. Details of the nature and type of information are described above.

At task 403, client 102-i will display such context information on or adjacent to the representation of the second customer displayed on Web page 300. A customer 103-i may access such context information by some customer action (e.g., pointing device near or over an icon or clicking on a specific portion of the icon).

At task 404, the communication system 100 enables audio (and possibly video) communication between a first customer and a second customer viewing Web page 300. In practice, a first customer will click (activate) the “Get-in-Touch” button to initiate a call to the second customer. IP telephony software 204-i in each of the clients associated with the first and second customers will enable such communication.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A computer implemented method comprising:
authenticating a first customer and a second customer to enable the first and second customers to access a retail Web site via the Internet;
displaying a representation of the first customer viewing a Web page of the retail Web site and a representation of the second customer viewing the Web page of the Web site; and
enabling audio communication between the first customer and the second customer.

2. The method of claim 1 wherein displaying includes displaying first and second icons representing the first and second customers, respectively.

3. The method of claim 1 further comprising displaying context information personalized to the first customer that relates to the second customer.

4. The method of claim 1 further comprising highlighting a representation of a customer viewing the Web page of particular interest to the first customer.

5. The method of claim 1 further comprising identifying a customer viewing the Web page by context information personalized to the first viewer.

6. The method of claim 1 further comprising displaying a representation of the first and second customers involved in the audio communication.

7. The method of claim 1 further comprising enabling video communication between the first customer and the second customer.

8. The method of claim 3 wherein displaying context information includes identifying one or more of the following:
commonly viewed Web pages of the retail Web site by the first and second customers;
duration of jointly viewed Web pages of the retail Web site by the first and second customers; and
commonly held shopping cart items via the retail Web site by the first and second customers.

9. The method of claim 6 further comprising enabling a third customer viewing the Web page to join the first and second customers involved in the audio communication.

10. A computer implemented method comprising:
authenticating a plurality of customers to enable the customers to access content from a retail Web site via the Internet;
displaying on a Web page of the retail Web site representations of each customer of the plurality of customers viewing the Web page; and
enabling audio communication between a first customer and a second customer viewing the Web page.

11. The method of claim 10 further comprising displaying context information personalized to the first customer that relates to the second customer.

12. The method of claim 10 further comprising highlighting a customer viewing the Web page of particular interest to the first customer.

13. The method of claim 10 wherein displaying includes displaying first and second icons representing the first and second customers, respectively.

14. The method of claim 10 further comprising displaying via the Web page a representation of the first and second customers involved in the audio communication.

15. The method of claim 11 wherein displaying context information includes identifying one or more of the following:
commonly viewed Web pages of the retail Web site by the first and second customers;
duration of jointly viewed Web pages of the retail Web site by the first and second customers; and
commonly held shopping cart items via the retail Web site by the first and second customers.

16. The method of claim 14 further comprising enabling a third customer viewing the Web page to join the first and second customers involved in the audio communication.

17. A computer implemented method comprising:
authenticating a first group of customers and a second group of customers to enable the customers to access content from a Web site via the Internet;
displaying on a Web page of the Web site representations of each group of customers viewing the Web page; and
enabling an audio conversation between a first customer viewing the Web page and a second customer viewing the Web page.

18. The method of claim 17 further comprising selecting the second customer viewing the Web page for communication based on context information personalized to the first viewer.
